(19) United States
(12) Patent Application Publication
(10) Pub. No.: US 2015/0288610 A1
(43) Pub. Date: Oct. 8, 2015

(54) RELAY APPARATUS FOR COMMUNICATION, RELAY SYSTEM FOR COMMUNICATION, RELAY METHOD FOR COMMUNICATION, AND RELAY PROGRAM FOR COMMUNICATION

(71) Applicant: NEC CORPORATION, Tokyo (JP)

(72) Inventor: Makoto Inoue, Tokyo (JP)

(73) Assignee: NEC Corporation, Tokyo (JP)

(21) Appl. No.: 14/441,931

(22) PCT Filed: Nov. 8, 2013
(86) PCT No.: PCT/JP2013/006579

§ 371 Date: May 11, 2015

(30) Foreign Application Priority Data
Nov. 12, 2012 (JP) 2012-248045

(51) Int. Cl. H04L 12/823; H04L 12/803; H04L 12/26; H04L 12/801

(52) U.S. Cl. CPC H04L 47/32; H04L 47/11; H04L 47/122; H04L 43/0882

(57) ABSTRACT

In order to make it possible to perform a data relay process without using a buffer even when a destination is in a congested state, a relay apparatus for communication includes a packet input process unit for identifying a destination of an input packet and determining whether or not the input packet is a packet related to a communication whose delay time is restricted, a congestion monitor unit for monitoring a congestion situation of the destination, and a delay unit for delaying output timing of a packet input by a given amount of time and then re-inputting the packet to the packet input process unit. The packet input process unit detour-transfers the input packet to the delay unit when the input packet is a packet related to a communication whose delay time is not restricted and the destination is in a congested state.

### TECHNICAL FIELD

The present invention relates to a relay apparatus provided between networks, and particularly concerns a relay apparatus for communication, a relay system for communication, a relay method for communication, and a relay program for communication that effectively realize data communication.

### BACKGROUND ART

Communication networks are provided with various relay apparatuses in order to accurately realize one-to-one data communication between a plurality of parties concerned. For example, a router that performs a control such that a packet reaches a correct receiver, an exchange (switch) that configures a communication line by switching connections between transmission paths according to a request of a sender, a relay for compensating the loss or distortion of a signal having occurred in a transmission path, and the like are such relay apparatuses.

Along with the recent increase of network scale, the number of these relay apparatuses arranged tends to increase, so that simplification of various configurations has been demanded from the aspect of packaging and costs.

For example, a packet switch apparatus equipped with an aforementioned exchange represented by an Ethernet (registered trademark) switch typically comprises a switch unit that integrates all the traffics and performs the switching of packets and a plurality of line units that includes an input/output interface for packet communication with outside and that performs transfer to the switch unit. According to the configuration made up of one switch unit and a plurality of line units, there is an advantage of being able to easily increase or decrease the number of line units.

However, in the packet switch apparatus, since a plurality of packets input from the outside can be transferred toward one output stage, there occurs a situation where packets collide with each other. Therefore, a typical packet switch apparatus is equipped with a configuration for controlling congestion (a phenomenon in which due to occurrence of many communication requests, communication of an amount that is an excess over the processing capability of a destination becomes impossible).

Furthermore, there is known a technology in which priorities of individual packets are set beforehand so that high-priority packets for which the packet sending delay is not permitted have priority of output even at the time of congestion, and low-priority packets for which delay is permitted for service usage are subjected to a discarding process at the time of congestion.

With regard to the aforementioned low-priority packets, there is also known a technology in which permission of delay for service usage is taken into account and such packets are not immediately discarded at the time of congestion but are accumulated temporarily in a buffer and thus keep the packets waiting until the congested state is dissolved. With this arrangement, in the case where the congested state has been dissolved while the low-priority packets are accumulated in the buffer, the low-priority packets can be sent to the destination. Specifically, the packet discard rate can be reduced.

However, due to limitation of the buffer capacity, when the amount of packets accumulated in the waiting side buffer exceeds a given amount, such packets are automatically discarded.

Furthermore, since such output control through the use of a buffer at the time of congestion is performed at a stage prior to switching, the buffer in the packet switch apparatus described above is disposed at an input side of a line unit provided side by side with the switch unit. Furthermore, since buffers that correspond to a certain output destination are provided in all the plurality of the line units, equipping with a huge capacity of buffers is required in the entire apparatus.

In addition, due to recent increase in the Internet traffic, improvement in services provided, and the like, the capacity of buffers to be provided in the apparatus tends to increase, so that the need for buffers has become a problem in the aspect of packaging and costs.

On the other hand, as for the switch disposed in a network in which the traffic of a carrier is managed, since a situation where congestion actually continues does not occur, the waiting process that uses a buffer is executed only when traffics collide with each other on rare occasions. Such collision between traffics is instantaneous, so that the waiting time in the buffer is also very short. However, a problem is that it is necessary to provide a large amount of buffers for such instantaneous waiting. In other words, the number of buffers provided in order to perform a packet-waiting process at the time of congestion becomes very large as in the foregoing configuration in which the carrier traffic management is not performed, and this is unfavorable from the viewpoint of the aspect of packaging and costs.

As a relevant technology, Patent Document 1 describes a packet switch that adopts a method (interleave process) in which a switch process is performed by regarding one physical port as a plurality of virtual communication paths in order to reduce the discard probability and improve the throughput (the processing capability per unit time). In this packet switch, a plurality of packets is sent and received in parallel through one physical port.

Furthermore, Patent Document 2 describes a technology in which in the case where the number of packets to be transferred exceeds the number thereof permitted to be accepted in a copy network that is a destination, the packets corresponding to the excess number are input again after being recirculated through a recirculation route.

### CITATION LIST

### Patent Literature

[PTL 1] Japanese Laid-open Patent Publication No. 2004-129313

[PTL 2] Published Japanese Translation of PCT International Publication for Patent Application No. 2002-515187

### SUMMARY OF THE INVENTION

### Technical Problem

However, the interleave process in the packet switch described in Patent Document 1 is executed by using buffers. Therefore, the technology of Patent Document 1 is not able to dissolve the disadvantage in the aspect of packaging and costs resulting from the arrangement of buffers as described above.

On the other hand, in the packet recirculation process described in Patent Document 2, after the sorting process by the switch is executed, excess packets above the number thereof permitted to be accepted by the destination are recirculated so as to be input again to the host apparatus. In other words, the packet recirculation process has a disadvantage that the process becomes complicated since the packet recirculation process cannot be executed unless a packet has once passed through the switch.

The present invention has been made in order to solve the foregoing problem, and an object of the invention is to provide a relay apparatus for communication, a relay system for communication, a relay method for communication, and a relay program for communication that are able to perform a data relay process without use of a buffer, even in the case where the destination is in a congested state.

### Solution to Problem

The relay apparatus for communication of the present invention includes a packet input process means for identifying a destination of an input packet and determining whether or not the input packet is a packet related to a communication whose delay time is restricted, a congestion monitor means for monitoring a congestion situation of the destination, and a delay means for delaying output timing of a packet input by a given amount of time and then re-inputting the packet to the packet input process means, and the packet input process means detour-transfers the input packet to the delay means when the input packet is a packet related to a communication whose delay time is not restricted and the destination is in a congested state.

The relay method for communication of the present invention includes: identifying a destination of an input packet; determining whether or not the input packet is a packet related to a communication whose delay time is restricted; and when the input packet is a packet related to a communication whose delay time is not restricted and the destination is in a congested state, detour-transferring the input packet to a delay means for delaying output timing of a packet input by a given amount of time and re-inputting the packet output from the delay means.

The relay program for communication of the present invention is a program for causing a computer of a relay apparatus for communication to execute processes of: identifying a destination of an input packet; determining whether or not the input packet is a packet related to a communication whose delay time is restricted; and when the input packet is a packet related to a communication whose delay time is not restricted and the destination is in a congested state, detour-transferring the input packet to a delay means for delaying output timing of a packet input by a given amount of time and re-inputting the packet output from the delay means.

### Advantageous Effects of the Invention

According to the present invention, even in the case where a destination is in a congested state, the data relay process can be realized without using a buffer.

### BRIEF DESCRIPTION OF THE DRAWINGS

FIG. 1 A block diagram illustrating a configuration example of a relay apparatus for communication in accordance with a first exemplary embodiment of the present invention

FIG. 2 A flowchart for describing an operation example of the relay apparatus for communication illustrated in FIG. 1

FIG. 3 A block diagram illustrating a configuration example of a relay apparatus for communication in accordance with a second exemplary embodiment of the present invention

FIG. 4 A flowchart for describing an operation example of the relay apparatus for communication illustrated in FIG. 3

FIG. 5 A block diagram illustrating a configuration example of a relay system for communication in accordance with a third exemplary embodiment of the present invention

FIG. 6 A block diagram illustrating a configuration example of a relay system for communication in accordance with a fourth exemplary embodiment of the present invention

FIG. 7 A flowchart for describing an operation example of each of the relay apparatuses for communication illustrated in FIG. 5 and FIG. 6

FIG. 8 A block diagram illustrating a configuration example of a relay apparatus for communication in accordance with a fifth exemplary embodiment of the present invention

### DESCRIPTION OF THE EMBODIMENTS

### First Exemplary Embodiment

### Description of Configuration

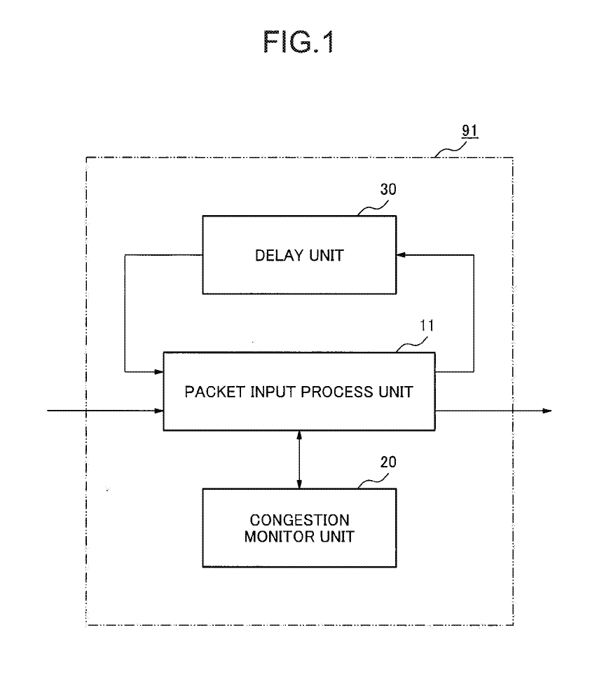

FIG. 1 is a block diagram illustrating a configuration example of a relay apparatus for communication 91 in accordance with a first exemplary embodiment of the present invention. The relay apparatus for communication 91 performs a relay process for each input packet.

The relay apparatus for communication 91 executes a QoS (Quality of Service, which is also called “priority control” as well). The QoS is a technology that guarantees communication quality for information (services) that flows through a network such as the Internet. For example, in the QoS, the delay time of a communication of information for which real-time processing is required, such as video pictures and voices, is restricted. On the other hand, the delay time of a communication for which real-time processing is not required, such as the sending and receiving of an e-mail and the browsing of sites, is not restricted.

In the case where a packet related to a communication whose delay time is restricted has been received, the relay apparatus for communication 91 sends the packet to destination without delaying the output timing. On the other hand, in the case where a packet related to a communication whose delay time is not restricted has been received, the relay apparatus for communication 91 can delay the output timing of the packet within a permissible delay time.

Incidentally, in the actual QoS, it is often the case that the service rank (quality rank of communication) is set to greater than or equal to 2; however, in the following description, in order to make descriptions clear, a case where there are two service ranks (i.e., two ways in which the output timing can or cannot be delayed) will be presented as an example.

In the following description, for the sake of convenience, a packet related to a communication whose delay time is restricted (a communication whose output timing cannot be delayed) will be called “restricted packet”, and a packet related to a communication whose delay time is not restricted (a communication whose output timing can be delayed) will be called “unrestricted packet”.

In other words, in this exemplary embodiment, all the packets are classified into either one of a restricted packet or an unrestricted packet. Incidentally, the method of distinguishing whether an input packet is a restricted packet or an unrestricted packet is arbitrary; however, for example, a method in which a header portion of a packet is provided beforehand with a prescription as to which kind of packet the packet is can be cited.

The relay apparatus for communication 91 includes a packet input process unit 11, a congestion monitor unit 20, and a delay unit 30.

The packet input process unit 11 analyzes a packet which is input (input packet) to identify the destination of the input packet and determine whether the input packet is a restricted packet or an unrestricted packet.

The congestion monitor unit 20 monitors a congestion situation of the destination identified by the packet input process unit 11, and outputs the result as “monitoring information”.

The delay unit 30 delays the output timing of the packet received from the packet input process unit 11 by a given amount of time, and then re-inputs the packet to the packet input process unit 11.

In the case where the input packet is a restricted packet, the packet input process unit 11 sends the input packet to the aforementioned identified destination.

On the other hand, in the case where the input packet is an unrestricted packet, the packet input process unit 11 acquires from the congestion monitor unit 20 information (monitoring information) regarding the congested state of the identified destination, and determines whether or not the destination is in a congested state on the basis of the monitoring information.

In the case where it has been determined that the destination is not in the congested state, the packet input process unit 11 outputs the input packet to the destination. On the other hand, in the case where it has been determined that the destination is in the congested state, the packet input process unit 11 detour-transfers the input packet to the delay unit 30.

Note that, for input to the packet input process unit 11, there exist two routes that are input from outside and input from the delay unit 30 as illustrated in FIG. 1. In the relay apparatus for communication 91 in accordance with the first exemplary embodiment, the processes that are to be performed on a packet after the packet has been input to corresponding one of the foregoing inputs are not discriminated but equal.

For example, in the case where the monitoring information indicates a congested state when the packet input from the outside or from the delay unit 30 is an unrestricted packet, the packet input process unit 11 sends the input packet to the delay unit 30 without discriminating input sources.

The delay unit 30, which is a block that outputs the arrival packet after a given amount of time, is able to adjust the delay value by a switch usage method.

### (Description of Operation)

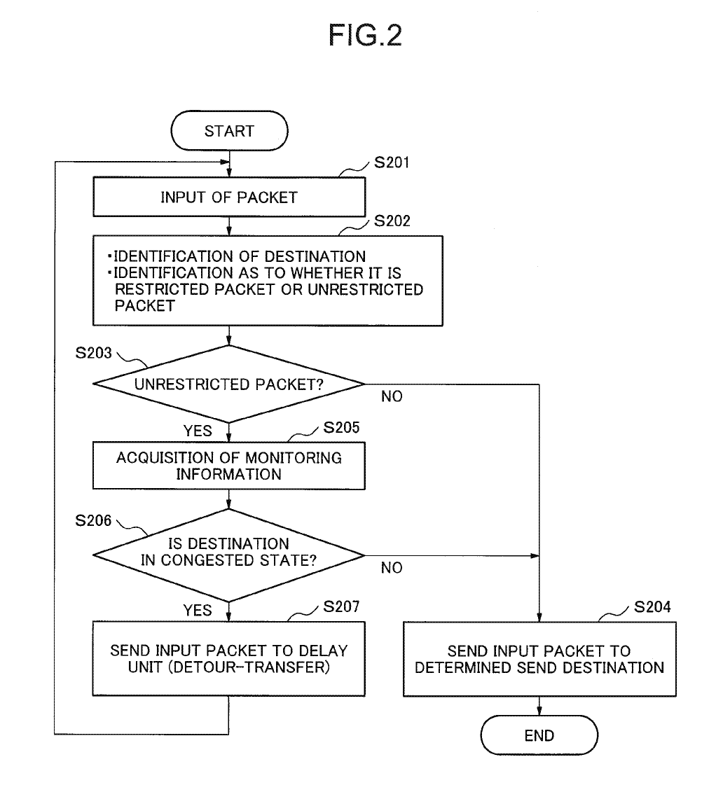

FIG. 2 is a flowchart for describing an operation example of the relay apparatus for communication 91.

The packet input process unit 11 takes input of a packet from outside or the delay unit 30 (step S201). The packet input process unit 11 identifies the destination of the input packet, and identifies whether the input packet is a restricted packet or an unrestricted packet (step S202). The packet input process unit 11 determines whether or not the input packet is an unrestricted packet (step S203).

In the case where the input packet is not an unrestricted packet (step S203: NO), the packet input process unit 11 sends the input packet (restricted packet) to the destination (step S204).

On the other hand, when the input packet is an unrestricted packet (step S203: YES), the packet input process unit 11 acquires monitoring information about the destination of the input packet, from the congestion monitor unit 20 (step S205). The packet input process unit 11 determines whether or not the destination is in a congested state on the basis of the acquired monitoring information (step S206).

When the destination is not in the congested state (step S206: NO), the packet input process unit 11 sends the input packet (unrestricted packet) to the destination (step S204).

On the other hand, when the destination is in the congested state (step S206: YES), the packet input process unit 11 outputs the input packet to the delay unit 30 (step S207).

The delay unit 30 delays the output timing of the unrestricted packet provided by detour-transfer by a given amount of time, and then re-inputs the packet to the packet input process unit 11 (step S201).

Then, after the process of the foregoing series of steps (steps S201 to S207) is repeatedly executed (i.e., the output timing of the unrestricted packet is delayed by a given amount of time) so that the destination is determined as the non-congested state, the unrestricted packet is finally sent to the destination (S204 in FIG. 2). Incidentally, in the foregoing description, the foregoing predetermined time is substantially equal to the product of the delay time of the delay unit 30 and the number of times of repetition.

Incidentally, the execution process of each step of steps S201 to S207 (FIG. 2) mentioned above may be programmed, and this series of control programs may be realized by a computer.

### (Description of Advantageous Effects)

The relay apparatus for communication 91 in accordance with the first exemplary embodiment described above includes, as a configuration for performing the process at the time of congestion, the delay unit 30 that delays the output timing of a packet received from the packet input process unit 11 by a given amount of time, and then re-inputs the packet to the packet input process unit 11. Due to this, a relay process of an unrestricted packet according to the congestion situation of the destination can be effectively performed without a buffer provided inside the apparatus. In other words, simplification of the entire apparatus can be performed.

Furthermore, not only the advantageous effect that disposal of a buffer becomes physically unnecessary, the complicated management of packets accumulated in a large amount within a buffer also becomes unnecessary. Due to this, occurrence of disadvantage resulting from accumulation of unnecessary data can be restrained.

Furthermore, in the first exemplary embodiment, in the case where at the time of input of a packet, the destination is in the congested state and the input packet cannot be sent to the outside, the delay unit 30 delays the output timing of the input packet provided by detour transfer by a given amount of time, and then re-inputs the packet to the packet input process unit 11. Therefore, if during this delay, the congestion of the destination is dissolved, the input packet can be sent.

Furthermore, in the case of the first exemplary embodiment, any delay can be adapted by changing the number of times of detour transfer. Therefore, flexible adaptation even to apparatuses that differ in product specifications or the like is possible.

Furthermore, in the relay apparatus for communication 91, the restricted packet is directly sent to the destination without detour transfer to the delay unit 30, regardless of the congestion situation of the destination. Due to this, it becomes possible to preferentially send the restricted packet, so that an event where a service whose service rank is high ends up in fail can be avoided.

Furthermore, since the processes in the two input routes provided in the packet input process unit 11 are substantially the same, the realization thereof, for example, through the use of an unused port of a general-purpose LSI (Large Scale Integration), is possible.

### Second Exemplary Embodiment

### Description of Configuration

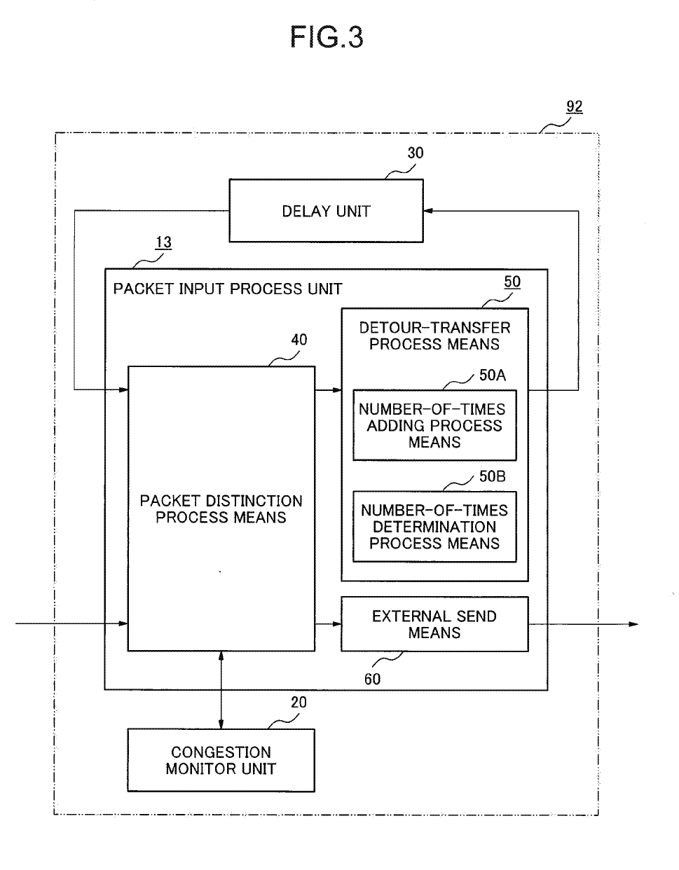

FIG. 3 is a block diagram illustrating a configuration example of a relay apparatus for communication 92 in accordance with a second exemplary embodiment of the present invention. Incidentally, in FIG. 3, the same component elements as in the foregoing first exemplary embodiment are given the same reference signs as in FIG. 1; therefore, descriptions thereof will be omitted below.

The relay apparatus for communication 92 performs replay processes of respective packets input.

The relay apparatus for communication 92 includes a packet input process unit 13, a congestion monitor unit 20, and a delay unit 30.

The congestion monitor unit 20 and the delay unit 30 are substantially the same as in the first exemplary embodiment (refer to FIG. 1). Therefore, descriptions thereof will be omitted.

The packet input process unit 13 includes a packet distinction process means 40, a detour transfer process means 50, and an external send means 60.

The packet distinction process means 40 includes an external interface (not depicted), and analyzes a packet which is input (input packet), identifies the destination of the input packet, and determines whether the input packet is a restricted packet or an unrestricted packet.

The detour transfer process means 50 executes a detour transfer process on the packet received from the packet distinction process means 40.

The external send means 60 sends to outside the packet received from the packet distinction process means 40.

In the case where the input packet is a restricted packet, the packet distinction process means 40 sends the input packet to the external send means 60. In other words, with regard to the restricted packet, the packet distinction process means 40 sends the packet to the external send means 60 without detour transfer to the delay unit 30, regardless of the content of the monitoring information (information regarding the congestion situation at the identified destination) acquired from the congestion monitor unit 20.

On the other hand, in the case where the input packet is an unrestricted packet, the packet distinction process means 40 executes a sending process based on the monitoring information.

Specifically, in the case where it has been determined that the aforementioned identified destination is in a congested state, the packet distinction process means 40 sends the input packet to the detour transfer process means 50. On the other hand, in the case where it has been determined that the aforementioned identified destination is not in the congested state, the packet distinction process means 40 sends the input packet to the external send means 60.

In other words, in the case where the input packet is a restricted packet or the case where the input packet is an unrestricted packet and the identified destination is not in the congested state, the packet distinction process means 40 sends the input packet to the outside via the external send means 60. On the other hand, in the case where the input packet is an unrestricted packet and the identified destination is in the congested state, the packet distinction process means 40 detour-transfers the input packet to the delay unit 30 via the detour transfer process means 50.

Note that since the packets that the detour transfer process means 50 receives are packets that are sent from the packet distinction process means 40 for detour transfer to the delay unit 30, the number of times of having received such a packet will be called “the number of times of detour” below.

The detour transfer process means 50 includes a number-of-times adding process means 50A and a number-of-times determination means SOB.

The number-of-times adding process means 50A adds up the number of times of having received a packet from the packet distinction process means 40 (number of times of detour), and stores the addition results.

In the case where a packet sent from the packet distinction process means 40 is a packet that has been received for the first time (a packet that has never been sent to the delay unit 30), the number of times of detour has not been stored. In this case, the number-of-times adding process means 50A assigns the number of times of detour with “1”, and stores this.

On the other hand, in the case where a packet sent from the packet distinction process means 40 is a packet that has been sent to the delay unit 30 at least once, the number-of-times adding process means 50A adds (increments) “1” to the immediately previously stored number of times of detour, and stores this result as a new number of times of detour.

The number-of-times determination process means 50B compares the number of times of detour counted by the number-of-times adding process means 50A and a predetermined threshold value of the number of times set beforehand by a maintenance person, and then executes a process pursuant to the result of the comparison.

Specifically, in the case where it has been determined that the number of times of detour exceeds the threshold value of the number of times, the number-of-times determination process means 50B discards the packet. On the other hand, in the case where it has been determined that the number of times of detour is less than or equal to the threshold value of the number of times, the number-of-times determination process means 50B detour-transfers the packet to the delay unit 30.

Note that, for input to the packet distinction process means 40, there exist two routes of input from the outside and of input from the delay unit 30 as illustrated in FIG. 3. In the relay apparatus for communication 92 in accordance with the second exemplary embodiment, the processes that are to be performed on a packet after the packet has arrived at corresponding one of the inputs of the packet distinction process means 40 are not discriminated but equal.

For example, in the case where the monitoring information indicates a congested state when the packet input from the outside or the delay unit 30 is an unrestricted packet, the input packet is sent to the delay unit 30 without discriminating the input sources.

Furthermore, as for the threshold value that serves as a reference for discarding a packet at the number-of-times determination process means 50B, a maintenance person sets an appropriate number of times of detour beforehand on the basis of the amount of time of one detour at the delay unit 30 and the delay permitted for the packet.

### (Description of Operation)

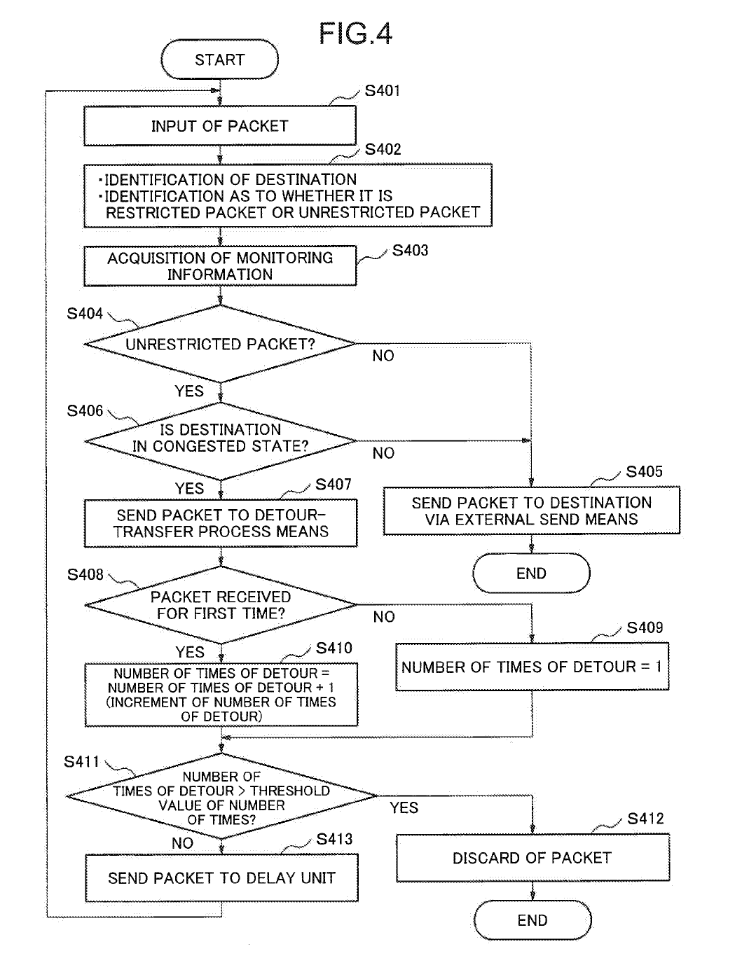

FIG. 4 is a flowchart for describing an operation example of the relay apparatus for communication 92.

The packet distinction process means 40 takes input of a packet from outside or the delay unit 30 (step S401). The packet distinction process means 40 identifies the destination of the input packet and identifies whether the input packet is a restricted packet or an unrestricted packet (step S402).

The packet distinction process means 40 acquires monitoring information about the destination of the input packet (step S403).

The packet distinction process means 40 determines whether or not the input packet is an unrestricted packet (step S404).

When the input packet is not an unrestricted packet (step S404: NO), the packet distinction process means 40 sends the input packet (restricted packet) to the destination via the external send means 60 (step S405).

On the other hand, when the input packet is an unrestricted packet (step S404: YES), the packet distinction process means 40 determines whether or not the destination is in a congested state on the basis of the acquired monitoring information (step S406).

When the destination is not in the congested state (step S406: NO), the packet distinction process means 40 sends the input packet (unrestricted packet) to the destination via the external send means 60 (step S405).

On the other hand, when the destination is in the congested state (step S406: YES), the packet distinction process means 40 sends the input packet (unrestricted packet) to the detour transfer process means 50 (step S407).

The number-of-times adding process means 50A determines whether or not the packet received from the packet distinction process means 40 is a packet that has been received for the first time (a packet that has never been detour-transferred to the delay unit 30) (step S408).

When the packet received from the packet distinction process means 40 is a packet that has been received for the first time (step S408: NO), the number-of-times adding process means 50A assigns the number of times of detour with “1” and stores this (step S409).

On the other hand, when the packet received from the packet distinction process means 40 is a packet that has been detour-transferred to the delay unit 30 at least once (step S408: YES), the number-of-times adding process means 50A adds (increments) “1” to the number of times of detour stored beforehand, and stores this result as the number of times of detour (step S410).

The number-of-times determination process means 50B determines whether or not the added-up number of times of detour exceeds the threshold value of the number of times (step S411).

When the added-up number of times of detour exceeds the threshold value of the number of times (step S411: YES), the number-of-times determination process means 50B discards the packet (step S412).

On the other hand, when the added-up number of times of detour does not exceed the threshold value of the number of times (step S411: NO), the number-of-times determination process means 50B detour-transfers the packet to the delay unit 30 (step S413).

The delay unit 30 delays the output timing of the packet received from the detour transfer process means 50 (specifically, the number-of-times determination process means 50B) by a given amount of time, and then re-inputs the packet to the packet distinction process means 40 (step S401).

Then, the process of each of the foregoing series of steps (steps S401 to S413) is repeatedly executed. The packet input process unit 13, ultimately, sends the packet to the destination (step S405) or discards the packet (step S412).

Incidentally, the execution process of each step of steps S401 to S412 mentioned above may be programmed, and this series of control programs may be realized by a computer.

### (Description of Advantageous Effects)

The second exemplary embodiment described above can achieve substantially the same advantageous effects as the first exemplary embodiment.

Furthermore, in the second exemplary embodiment, when the number of times that the detour transfer process means 50 has received a packet from the packet distinction process means 40 (the number of times of detour) exceeds the threshold value of the number of times, the number-of-times determination process means 50B discards the packet. Therefore, it becomes possible to avoid an event where an unrestricted packet resides in the detour route for a long drawn-out time, and a packet with a delay that is not meet the requirement for a service can be prevented from impeding the transfer process of other effective packets.

Furthermore, for input of a packet from outside and from the detour path (delay unit 30), the packet distinction process means 40 is provided with two kinds of inputs. However, as mentioned above, the process in the two input routes are not discriminated but equal. Therefore, for example, realization of the input process through the use of an unused port of a general-purpose LSI is possible. Likewise, the detour transfer process means 50, the external send means 60 or the like can also be configured by utilizing an unused port. In other words, since an unused port can be effectively used, there is no need to add a new component.

### Third Exemplary Embodiment

### Description of Configuration

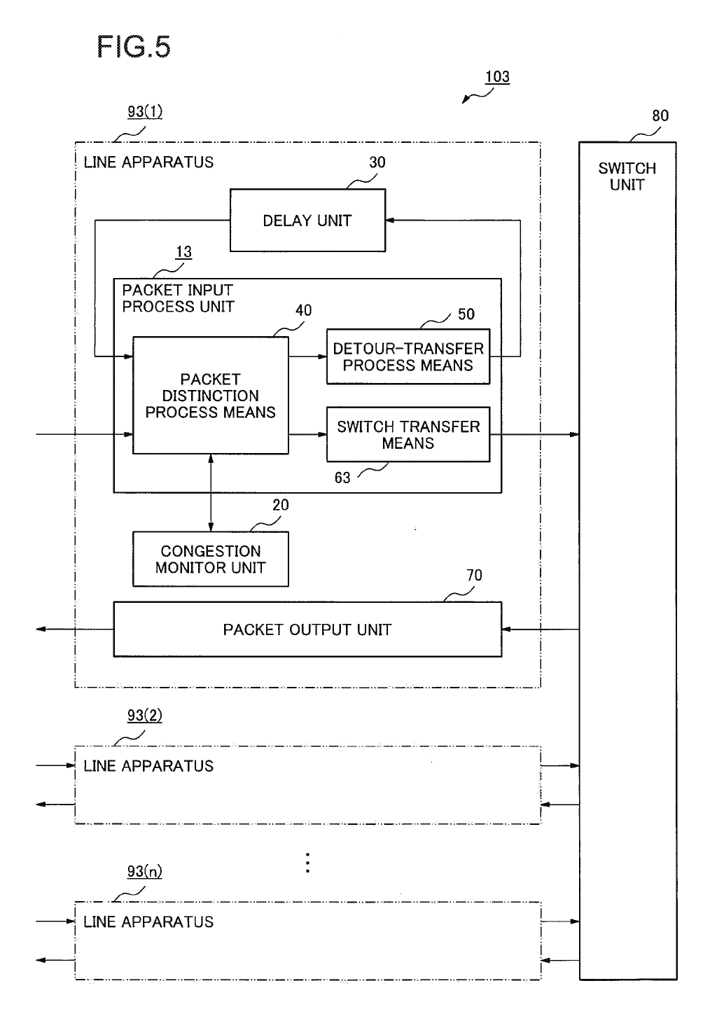

FIG. 5 is a block diagram illustrating a configuration example of a relay system for communication 103 in accordance with a third exemplary embodiment of the present invention. Incidentally, in FIG. 5, the same component elements as in the first exemplary embodiment and the second exemplary embodiment are denoted by the same reference signs as in FIG. 1 or FIG. 3; at the same time, description thereof will be omitted below.

The relay system for communication 103 sorts packets input from outside, and transfers packets at appropriate times.

In addition to the configuration of the relay apparatus for communication 92 (refer to FIG. 3) in accordance with the second exemplary embodiment, the relay system for communication 103 further includes a plurality of line apparatuses 93(1 to n) each of which includes a packet output unit 70 for outputting a transferred packet to the outside. Note that n is a natural number. Still further, the relay system for communication 103 includes a switch unit 80 that includes interfaces (not depicted) with the line apparatuses 93(1 to n) and that, via each of the interfaces, receives a transferred packet from each of the line apparatuses 93(1 to n) and transfers the packet to any one of the line apparatuses 93(1 to n).

Note that a switch transfer means 63 has the same configuration as the external send means 60 (FIG. 3) in the second exemplary embodiment. Furthermore, other elements (a packet input process unit 13, a congestion monitor unit 20, a delay unit 30, a packet distinction process means 40, and a detour transfer process means 50) also have the same configuration as those elements in the second exemplary embodiment.

In the third exemplary embodiment, the packet distinction process means 40 identifies any one of the line apparatuses 93(1 to n) as a destination pursuant to each input packet. Note that the line apparatus 93(one of 1 to n) as a destination pursuant to each input packet which the packet distinction process means 40 identifies will be called a specific line apparatus 93.

Furthermore, the congestion monitor unit 20 monitors the congestion situation of each of the line apparatuses 93(1 to n) as a destination.

In other words, when an input packet is an unrestricted packet, the packet distinction process means 40 acquires information regarding the congestion situation of the specific line apparatus 93 (monitoring information) from the congestion monitor unit 20, and determines whether or not the specific line apparatus 93 is in a congested state on the basis of this information.

The configurations of the line apparatuses 93(1 to n) are the same. In other words, packets input to each of the line apparatuses 93(1 to n) go through substantially the same steps (steps S401 to 413 in FIG. 4) as in the second exemplary embodiment, and are sent to the switch unit 80 from the switch transfer means 63 or discarded at the detour transfer process means 50.

Furthermore, the switch unit 80 that has received a packet from the switch transfer means 63 transfers the packet to the specific line apparatus 93. In the specific line apparatus 93 having received this packet, the packet output unit 70 outputs the packet to an external interface (not depicted).

### (Description of Operation)

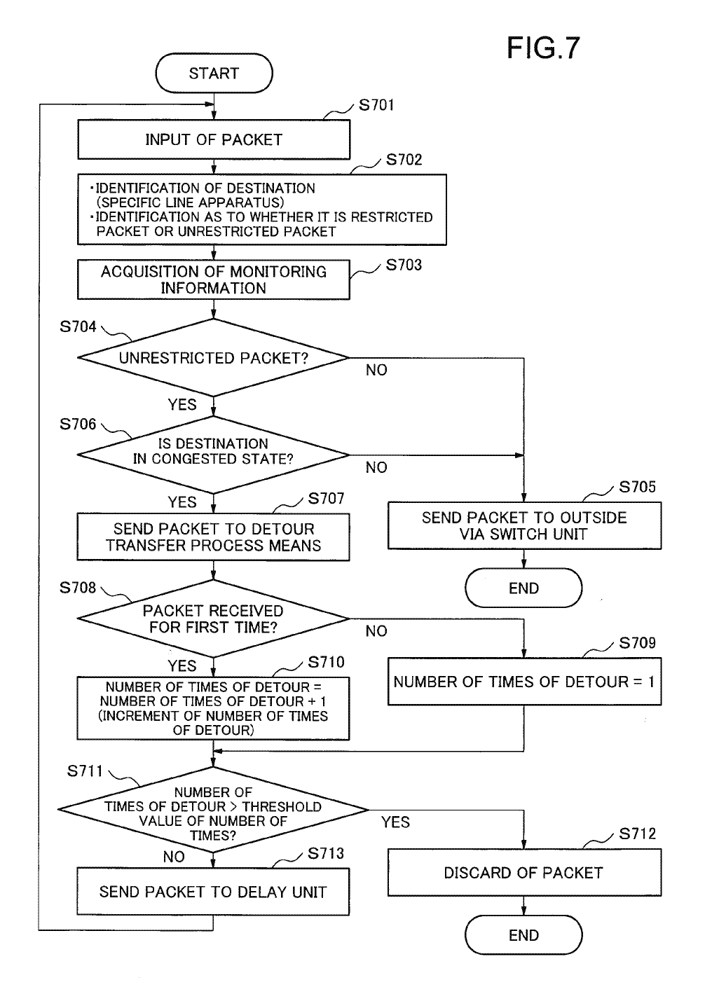

FIG. 7 is a flowchart for describing an operation example of the relay system for communication 103.

The packet distinction process means 40 takes input of a packet from outside or the delay unit 30 (step S701). The packet distinction process means 40 determines the destination of the input packet (specific line apparatus 93) and identifies whether the input packet is a restricted packet or an unrestricted packet (step S702).

The packet distinction process means 40 acquires monitoring information about the specific line apparatus 93 (step S703).

The packet distinction process means 40 determines whether or not the input packet is an unrestricted packet (step S704).

When the input packet is not an unrestricted packet (step S704: NO), the packet distinction process means 40 sends the input packet (restricted packet) to the switch unit 80 via the switch transfer means 63 (step S705). The switch unit 80 transfers the received packet to the packet output unit 70 in the specific line apparatus 93. The packet output unit 70 outputs the received packet to the external interface.

On the other hand, when the input packet is an unrestricted packet (step S704: YES), the packet distinction process means 40 determines whether or not the destination (specific line apparatus 93) is in a congested state on the basis of the acquired monitoring information (step S706).

When the specific line apparatus 93 is not in the congested state (step S706: NO), the packet distinction process means 40 sends the input packet (unrestricted packet) to the switch unit 80 via the switch transfer means 63 (step S705). The switch unit 80 transfers the received packet to the packet output unit 70 in the specific line apparatus 93. The packet output unit 70 outputs the received packet to the external interface.

On the other hand, when the specific line apparatus 93 is in a congested state (step S706: YES), the packet distinction process means 40 sends the input packet (unrestricted packet) to the detour transfer process means 50 (step S707).

The detour transfer process means 50 determines whether or not the packet received from the packet distinction process means 40 is a packet that has been received for the first time (a packet that has never been detour-transferred to the delay unit 30) (step S708).

When the packet received from the packet distinction process means 40 is a packet that has been received for the first time (step S708: NO), the detour transfer process means 50 assigns the number of times of detour with “1” and stores this (step S709).

On the other hand, when the packet received from the packet distinction process means 40 is a packet that has been detour-transferred to the delay unit 30 at least once (step S708: YES), the detour transfer process means 50 adds (increments) “1” to the number of times of detour stored beforehand, and stores this result as the number of times of detour (step S710).

The detour transfer process means 50 determines whether or not the added-up number of times of detour exceeds the threshold value of the number of times (step S711).

When the added-up number of times of detour exceeds the threshold value of the number of times (step S711: YES), the detour transfer process means 50 discards the packet (step S712).

On the other hand, when the added-up number of times of detour does not exceed the threshold value (step S711: NO), the detour transfer process means 50 detour-transfers the packet to the delay unit 30 (step S713).

The delay unit 30 delays the output timing of the detour-transferred packet by a given amount of time, and then re-inputs the packet to the packet distinction process means 40 (step S701).

Then, the process of each of the foregoing series of steps (steps S701 to S713) is repeatedly executed. The packet input process unit 13, ultimately, sends the packet to the specific line apparatus 93 (step S705) or discards the packet (step S712).

Incidentally, the execution process of each step of steps S701 to S713 mentioned above may be programmed, and this series of control programs may be realized by a computer.

### (Description of Advantageous Effects)

The third exemplary embodiment described above can achieve advantageous effects comparable to those of the second exemplary embodiment.

Furthermore, in the relay system for communication 103 in accordance with the third exemplary embodiment, when the specific line apparatus 93 is in a congested state, the line apparatuses 93(1 to n) having taken input of an unrestricted packet transfers the unrestricted packet to the delay unit 30 provided on a detour route within the line apparatuses 93(1 to n). In other words, the line apparatuses 93(1 to n) are able to realize the time adjustment of the output timing of the unrestricted packet without using a buffer. Therefore, it becomes unnecessary to provide a buffer within each of the line apparatuses 93(1 to n), the problem in the aspect of packaging and cost caused by the provision of a buffer is dissolved. Furthermore, the complicated management of accumulated packets that becomes a problem at the time of a process using a buffer becomes unnecessary.

Furthermore, in the case where at the time of arrival of an unrestricted packet, the specific line apparatus 93 is in a congested state and the packet cannot be transferred to the switch unit 80, the unrestricted packet is neither sent to the destination nor discarded, but resides within the detour route during a permissible delay time. Therefore, if during this delay time, the congestion is dissolved, the unrestricted packet can be transferred to the switch unit 80. On the other hand, in the case where the number of times of detour exceeds the threshold value of the number of times, the packet is discarded. From what has been described above, according to this exemplary embodiment, the rise in the packet discard rate can be restrained as much as possible, and an event where an unnecessary packet uselessly resides on the detour route can be avoided.

### Fourth Exemplary Embodiment

### Description of Configuration

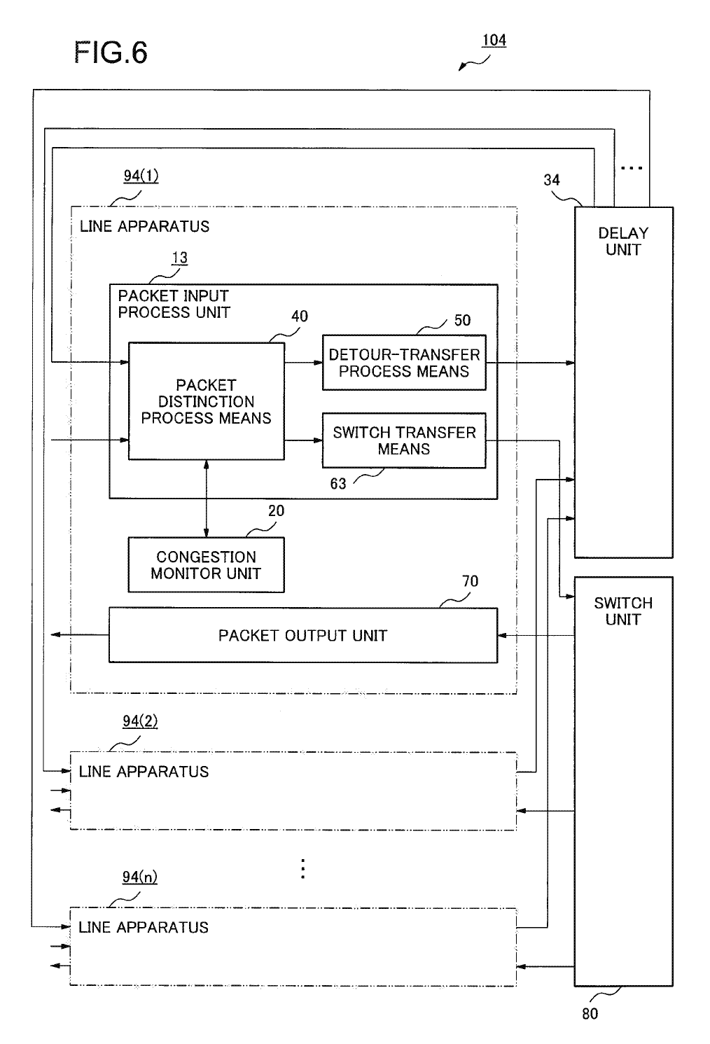

FIG. 6 is a block diagram illustrating a configuration example of a relay system for communication 104 in accordance with a fourth exemplary embodiment of the present invention. Incidentally, in FIG. 6, the same component elements as in the foregoing first to third exemplary embodiments are denoted by the same reference signs as in FIG. 1, FIG. 3 and FIG. 5; at the same time, descriptions thereof will be omitted below.

The relay system for communication 104 sorts packets input from outside and transfers the packets at appropriate times.

A feature of the relay system for communication 104 is that the entire system shares one delay unit 34 instead of disposing a delay unit 30 in each of the line apparatuses 93(1 to n) as in the relay system for communication 103 in the third exemplary embodiment.

In other words, the relay system for communication 104 includes a plurality of line apparatuses 94(1 to n), one delay unit 34, and a switch unit 80.

The line apparatuses 94(1 to n) have the same configuration as the line apparatuses 93(1 to n) of the third exemplary embodiment, except that the line apparatuses 94(1 to n) do not include a delay unit 30.

The delay unit 34 delays the output timing of a packet detour-transferred from each of the line apparatuses 94(1 to n) by a given amount of time, and re-inputs the packet to a line apparatus 94(one of 1 to n). The configuration of the delay unit 34 itself is the same as that of the delay unit 30 (refer to FIG. 5) in the third exemplary embodiment.

The switch unit 80 includes interfaces (not depicted) with the plurality of the line apparatuses 94(1 to n), and, via the interfaces, receives a transferred packet from each of the line apparatuses 94(1 to n) and sends the packet to one of the line apparatuses 94(1 to n).

### (Description of Operation)

Operations of the relay system for communication 104 are basically the same as the operations of the relay system for communication 103 of the third exemplary embodiment (FIG. 7).

However, a difference is that in the case where the added-up number of times of detour does not exceed a threshold value, the third exemplary embodiment detour-transfers an input packet to the delay unit 30 provided in each of the line apparatuses 93(1 to n), whereas the fourth exemplary embodiment detour-transfers an input packet to the delay unit 34 that is shared by the entire system (that is provided outside the line apparatuses 93(1 to n)).

Incidentally, the execution process of each step (the steps S701 to S713) in accordance with the relay system for communication 104, which is executed in substantially the same manner as in the foregoing third exemplary embodiment, may be programmed, and this series of control programs may be realized by a computer.

### (Description of Advantageous Effects)

The fourth exemplary embodiment described above can achieve substantially the same advantageous effects as the third exemplary embodiment.

Furthermore, in the case of the fourth exemplary embodiment, a configuration in which the delay unit 34 is shared in the system and is shared by the plurality of the line apparatuses 94(1 to n) is adopted. Due to this, it becomes possible to accomplish the sharing of resources in the case where the delay unit 34 is caused to have a large delay. Furthermore, since a delay unit as a component member is absent in each of the line apparatuses 94(1 to n), superiority in the aspect of packaging and costs can be shown.

Incidentally, the delay unit 34 in the fourth exemplary embodiment may be provided in the form of a buffer. In this manner, the buffer memories disposed separately for each line apparatus can be shared by a plurality of line apparatuses in the form of a single buffer. In this manner, even in the case where a buffer is used, disadvantage from the viewpoint of the aspect of packaging and costs can be dissolved or a reduced.

### Fifth Exemplary Embodiment

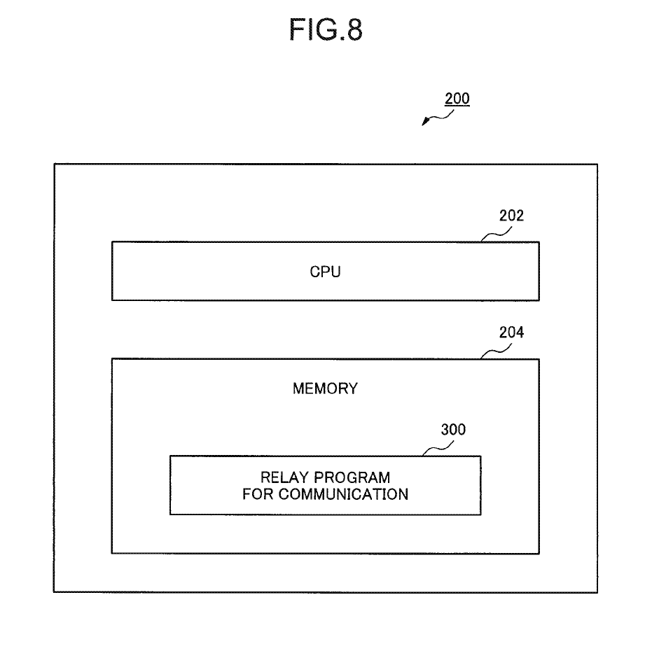

FIG. 8 is a block diagram illustrating a configuration example of a relay apparatus for communication 200 in accordance with a fifth exemplary embodiment of the present invention. The relay apparatus for communication 200 includes a CPU (Central Processing Unit) 202 and a memory 204.

The memory 204 stores a relay program for communication 300. The relay program for communication 300 is executed by a CPU 202. As an example of the memory 204, there can be cited non-transitory storage means, for example, a ROM (Read Only Memory), a hard disk, a removable medium, a removable disk, or the like.

The relay program for communication 300 is one obtained by programming the process illustrated by the flowchart in FIG. 2 (steps S201 to 207). The foregoing process includes a first process and a second process.

The first process is a process in which the destination of an input packet is identified and it is determined whether or not the input packet is a packet related to a communication whose delay time is restricted.

The second process is a process in which, when an input packet is a packet related to a communication whose delay time is not restricted and the destination is in a congested state, the input packet is detour-transferred to a delay means for delaying the output timing of the input packet by a given amount of time, and the packet output from the delay means is re-input.

The fifth exemplary embodiment described above can achieve substantially the same advantageous effects as the first exemplary embodiment.

Furthermore, the foregoing exemplary embodiments are preferred specific examples of the relay apparatus for communication, the relay system for communication, the relay method for communication and the relay program for communication, in which, in some cases, technically preferable various limitations are provided. However, the technical scope of the present invention is not limited to these modes unless there is a mention that particularly limits the present invention.

Given below is summarized points of novel technical contents of the foregoing exemplary embodiments. However, the present invention is not necessarily limited to these points.

### (Supplementary Note 1)

A relay apparatus for communication characterized by including:

packet input process means for identifying a destination of an input packet and determining whether or not the input packet is a packet related to a communication whose delay time is restricted;

congestion monitor means for monitoring a congestion situation of the destination; and

delay means for delaying output timing of a packet input by a given amount of time and then re-inputting the packet to the packet input process means,

wherein the packet input process means detour-transfers the input packet to the delay means in the case where the input packet is a packet related to a communication whose delay time is not restricted and the destination is in a congested state.

### (Supplementary Note 2)

The relay apparatus for communication according to the supplementary note 1, characterized in that the packet input process means transfers the input packet to the destination without detour-transferring the input packet to the delay means in the case where the input packet is the packet related to the communication whose delay time is restricted.

### (Supplementary Note 3)

The relay apparatus for communication according to the supplementary note 1, characterized in that the packet input process means counts a number of times that the input packet has been detour-transferred to the delay means, and discards the input packet in the case where the counted number of times is equal to or larger than a predetermined threshold value of the number of times.

### (Supplementary Note 4)

The relay apparatus for communication according to any one of the supplementary notes 1 to 3, characterized in that

a plurality of the packet input process means is provided, and

the plurality of the packet input process means shares the delay means and the congestion monitor means.

### (Supplementary Note 5)

The relay apparatus for communication according to any one of the supplementary notes 1 to 3, characterized in that

a plurality of the packet input process means is provided and a plurality of the congestion monitor means is provided and associated individually with the plurality of the packet input process means, and

the plurality of the packet input process means shares the delay means.

### (Supplementary Note 6)

The relay apparatus for communication according to any one of the supplementary notes 1 to 3, characterized in that

a plurality of the packet input process means is provided and a plurality of the congestion monitor means and a plurality of the delay means are provided and associated with the plurality of the packet input process means.

### (Supplementary Note 7)

A relay system for communication characterized by including:

the relay apparatus for communication according to any one of the supplementary notes 4 to 6; and

a switch means for sorting and transferring a packet received from the packet input process means,

wherein when sending the input packet to the identified destination, the packet input process means sends the input packet via the switch means.

### (Supplementary Note 8)

A relay system for communication characterized by including:

the relay apparatus for communication according to any one of the supplementary notes 4 to 6;

switch means for sorting and transferring a packet received from the packet input process means; and

a plurality of packet output means for outputting to outside the packet sorted and transferred from the switch means, the plurality of the packet output means being associated individually with the plurality of the packet input process means,

wherein the packet input process means identifies any one of the plurality of the packet output means as the destination pursuant to the input packet.

### (Supplementary Note 9)

A relay method for communication comprising:

identifying a send destination of an input packet;

determining whether or not the input packet is a packet related to a communication whose delay time is restricted;

in the case where the input packet is a packet related to a communication whose delay time is not restricted and the send destination is in a congested state, the input packet to a delay means for delaying output timing of a packet input by a given amount of time and re-inputting the packet output from the delay means.

### (Supplementary Note 10)

The relay method for communication according to the supplementary note 9, characterized in that in the case where the input packet is the packet related to the communication whose delay time is restricted, the input packet is transferred to the destination without being detour-transferred to the delay means.

### (Supplementary Note 11)

The relay method for communication according to the supplementary note 9, characterized in that a number of times that the input packet has been detour-transferred to the delay means is counted, and the input packet is discarded in the case where the counted number of times is equal to or larger than a predetermined threshold value of the number of times.

### (Supplementary Note 12)

A relay program for communication for causing a computer of a relay apparatus for communication to execute processes of:

identifying a send destination of an input packet;

determining whether or not the input packet is a packet related to a communication whose delay time is restricted; and

in the case where the input packet is a packet related to a communication whose delay time is not restricted and the send destination is in a congested state, detour-transferring the input packet to a delay means for delaying output timing of a packet input by a given amount of time and re-inputting the packet output from the delay means.

### (Supplementary Note 13)

The relay program for communication according to the supplementary note 12, characterized in that the input packet is transferred to the destination without being detour-transferred to the delay means in the case where the input packet is the packet related to the communication whose delay time is restricted.

### (Supplementary Note 14)

The relay program for communication according to the supplementary note 12, characterized in that a number of times that the input packet has been transferred as a detour route to the delay means is counted, and the input packet is discarded in the case where the counted number of times is equal to or larger than a predetermined threshold value of the number of times.

While the invention of the present application has been described above with reference to the exemplary embodiments, the invention of the present application is not limited to the foregoing exemplary embodiments. Configurations or details of the invention of the present application can be changed in various manners that a person having ordinary skill in the art can understand within the scope of the invention of the present application.

This application claims the benefit of the priority based on Japanese Patent Application No. 2012-248045 filed on Nov. 12, 2012, the disclosure of which is incorporated herein in its entirety by reference.

### INDUSTRIAL APPLICABILITY

The present invention is applicable to switch apparatuses and the like for use in communication infrastructures such as Ethernet switches and routers.

### REFERENCE SIGNS LIST

11, 13 packet input process unit
20 congestion monitor unit
30, 34 delay unit
40 packet distinction process means
50 detour transfer process means
50A number-of-times adding process means
50B number-of-times determination process means
60 external send means
63 switch transfer means
70 packet output unit
80 switch unit
91, 92 relay apparatus for communication
93(1 to n), 94(1 to n) line apparatus
103, 104 relay system for communication
200 relay apparatus for communication
202 CPU
204 memory
300 relay program for communication

1. A relay apparatus for communication comprising:
a packet input process unit that identifies a send destination of an input packet and determining whether or not the input packet is a packet related to a communication whose delay time is restricted;
a congestion monitor unit that monitors a congestion situation of the send destination; and
a delay unit that delays output timing of a packet input by a given amount of time and then re-inputting the packet to the packet input process unit,
wherein the packet input process unit detour-transfers the input packet to the delay unit when the input packet is a packet related to a communication whose delay time is not restricted and the send destination is in a congested state.

2. The relay apparatus for communication according to claim 1, wherein
the packet input process unit transfers the input packet to the send destination without detour-transferring the input packet to the delay unit when the input packet is the packet related to the communication whose delay time is restricted.

3. The relay apparatus for communication according to claim 1, wherein
the packet input process unit counts a number of times that the input packet has been detour-transferred to the delay unit, and discards the input packet when the counted number of times is equal to or larger than a predetermined threshold value of the number of times.

4. The relay apparatus for communication according to claim 1, wherein
a plurality of the packet input process unit is provided, and
the plurality of the packet input process unit shares the delay unit and the congestion monitor unit.

5. The relay apparatus for communication according to claim 1, wherein
a plurality of the packet input process unit is provided and a plurality of the congestion monitor unit is provided and associated individually with the plurality of the packet input process unit, and
the plurality of the packet input process unit shares the delay unit.

6. The relay apparatus for communication according to claim 1, wherein
a plurality of the packet input process unit are provided, and a plurality of the congestion monitor unit and a plurality of the delay unit are provided and associated individually with the plurality of the packet input process unit.

7. A relay system for communication comprising:
the relay apparatus for communication according to claim 4; and
switch unit for sorting and transferring a packet received from the packet input process unit,
wherein when sending the input packet to the identified send destination, the packet input process unit sends the input packet via the switch unit.

8. A relay system for communication comprising:
the relay apparatus for communication according to claim 4;
a switch unit for sorting and transferring a packet received from the packet input process unit; and
a plurality of packet output unit for outputting to an outside the packet sorted and transferred from the switch unit, the plurality of the packet output unit being associated individually with the plurality of the packet input process unit,
wherein the packet input process unit identifies any one of the plurality of the packet output unit as the send destination pursuant to the input packet.

9. A relay method for communication comprising:
identifying a send destination of an input packet; determining whether or not the input packet is a packet related to a communication whose delay time is restricted; and when the input packet is a packet related to a communication whose delay time is not restricted and the send destination is in a congested state, detour-transferring the input packet to a delay unit that delays output timing of a packet input by a given amount of time and re-inputting the packet output from the delay unit.

10. (canceled)

11. The relay method for communication according to claim 9, characterized in that in the case where the input packet is the packet related to the communication whose delay time is restricted, the input packet is transferred to the destination without being detour-transferred to the delay unit.

12. The relay method for communication according to claim 9, characterized in that a number of times that the input packet has been detour-transferred to the delay unit is counted, and the input packet is discarded in the case where the counted number of times is equal to or larger than a predetermined threshold value of the number of times.

13. A relay apparatus for communication comprising:
packet input process means for identifying a send destination of an input packet and determining whether or not the input packet is a packet related to a communication whose delay time is restricted;
congestion monitor means for monitoring a congestion situation of the send destination; and
delay means for delaying output timing of a packet input by a given amount of time and then re-inputting the packet to the packet input process means,
wherein the packet input process means detour-transfers the input packet to the delay means when the input packet is a packet related to a communication whose delay time is not restricted and the send destination is in a congested state.
